(19) United States
(12) Patent Application Publication
(10) Pub. No.: US 2013/0317894 A1
(43) Pub. Date: Nov. 28, 2013

(54) METHOD AND APPARATUS FOR PROVIDING TEMPLATE-BASED DISCOUNT VALUATION AND RANKING

(71) Applicants: Hengshu Zhu, Anhui (CN); Jilei Tian, Beijing (CN); Hao Yang, Montrose, NY (US); Zhanjian Song, Beijing (CN)

(72) Inventors: Hengshu Zhu, Anhui (CN); Jilei Tian, Beijing (CN); Hao Yang, Montrose, NY (US); Zhanjian Song, Beijing (CN)

(73) Assignee: NOKIA CORPORATION, Espoo (FI)

(21) Appl. No.: 13/992,910

(22) PCT Filed: Dec. 10, 2010
(86) PCT No.: PCT/CN2010/079666

§ 371 Date: Aug. 12, 2013

(51) Int. Cl. G06Q 30/02

(52) U.S. Cl. CPC G06Q 30/0211
USPC 705/14.13

(57) ABSTRACT

An approach is provided for template-based discount valuation and ranking. A discount management platform processes or facilitates a processing of a vocabulary for representing one or more parameters of discount information associated with one or more discount types. The discount management platform then processes or facilitates a processing of the one or more discount types to generate one or more templates based, at least in part, on the vocabulary. The one or more templates include, at least in part, one or more labels, one or more input fields, or a combination thereof for calculating and/or facilitating a calculation of one or more discount values associated with the discount information.

### BACKGROUND

Service providers and device manufacturers (e.g., wireless, cellular, etc.) are continually challenged to deliver value and convenience to consumers by, for example, providing compelling network services. Such services can often include shopping services and/or related marketing services. One area of interest has been the development of services that facilitate marketing promotions or discounts (e.g., coupons or other similar discount offers) provided from retailers to users. However, marketing promotions and discounts can vary greatly from simple offers (e.g., 10% off) to more complex multi-part discounts (e.g., buy a first item at full price, then get the second item at 50% off and then a third item at 75% off). Accordingly, service providers and device manufacturers face significant technical challenges to enabling users to efficiently determine the comparative values of such marketing promotions and or discounts.

### Some Example Embodiments

Therefore, there is a need for an approach for efficiently and consistently calculating and/or comparing discount offers across a variety of discount types.

According to one embodiment, a method comprises processing and/or facilitating a processing of a vocabulary for representing one or more discount parameters associated with one or more discount types. The method also comprises processing and/or facilitating a processing of the one or more discount types to generate one or more templates based, at least in part, on the vocabulary. The one or more templates include, at least in part, one or more labels, one or more input fields, or a combination thereof for calculating and/or facilitating a calculation of one or more discount values associated with the discount information. In some embodiments, the method further comprises receiving the discount information for one or more items and processing and/or facilitating a processing of the discount information to populate at least a portion of the one or more templates.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of a vocabulary for representing one or more discount parameters associated with one or more discount types. The apparatus is also caused to process and/or facilitate a processing of the one or more discount types to generate one or more templates based, at least in part, on the vocabulary. The one or more templates include, at least in part, one or more labels, one or more input fields, or a combination thereof for calculating and/or facilitating a calculation of one or more discount values associated with the discount information. In some embodiments, the apparatus is further caused to receive the discount information for one or more items and to process and/or facilitate a processing of the discount information to populate at least a portion of the one or more templates.

According to another embodiment, a computer-readable storage medium carries one or more sequences of one or more instructions which, when executed by one or more processors, cause, at least in part, an apparatus to process and/or facilitate a processing of a vocabulary for representing one or more discount parameters associated with one or more discount types. The apparatus is also caused to process and/or facilitate a processing of the one or more discount types to generate one or more templates based, at least in part, on the vocabulary. The one or more templates include, at least in part, one or more labels, one or more input fields, or a combination thereof for calculating and/or facilitating a processing of one or more discount values associated with the discount information. In some embodiments, the apparatus is further caused to receive the discount information for one or more items and to process and/or facilitate a processing of the discount information to populate at least a portion of the one or more templates.

According to another embodiment, an apparatus comprises means for processing and/or facilitating a processing of a vocabulary for representing one or more discount parameters associated with one or more discount types. The apparatus also comprises means for processing and/or facilitating a processing of the one or more discount types to generate one or more templates based, at least in part, on the vocabulary. The one or more templates include, at least in part, one or more labels, one or more input fields, or a combination thereof for calculating one or more discount values associated with the discount information. In some embodiments, the apparatus further comprises means for receiving the discount information for one or more items and for causing, at least in part, processing of the discount information to populate at least a portion of the one or more templates.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing template-based discount valuation and ranking, according to one embodiment;

FIG. 2 is a diagram of the components of user equipment capable of template-based discount valuation and ranking, according to one embodiment;

FIG. 3 is a diagram of the components of a discount management platform, according to one embodiment;

FIG. 4 is a flowchart of a process for creating discount templates, according to one embodiment;

FIG. 5 is a flowchart of a process for populating discount templates and ranking discount offers, according to one embodiment;

FIG. 6 is a flowchart of a process for determining recommended discount templates, according to one embodiment;

FIGS. 7A and 7B are diagrams of user interfaces utilized in the processes of FIGS. 4-6, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing template-based discount valuation and ranking are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “discount” refers to offers, deals, promotions, advertisements, etc. that provide price reductions, incentives (e.g., free items, free services, etc.), or other consideration for goods (e.g., physical items, electronic items, other non-tangible items, etc.) and/or services. In one embodiment, discounts may be provided as coupons. As used herein the term “coupon” refers to a document, file, token, etc. that can be presented to receive a discount or rebate related to a transaction for goods and/or services.

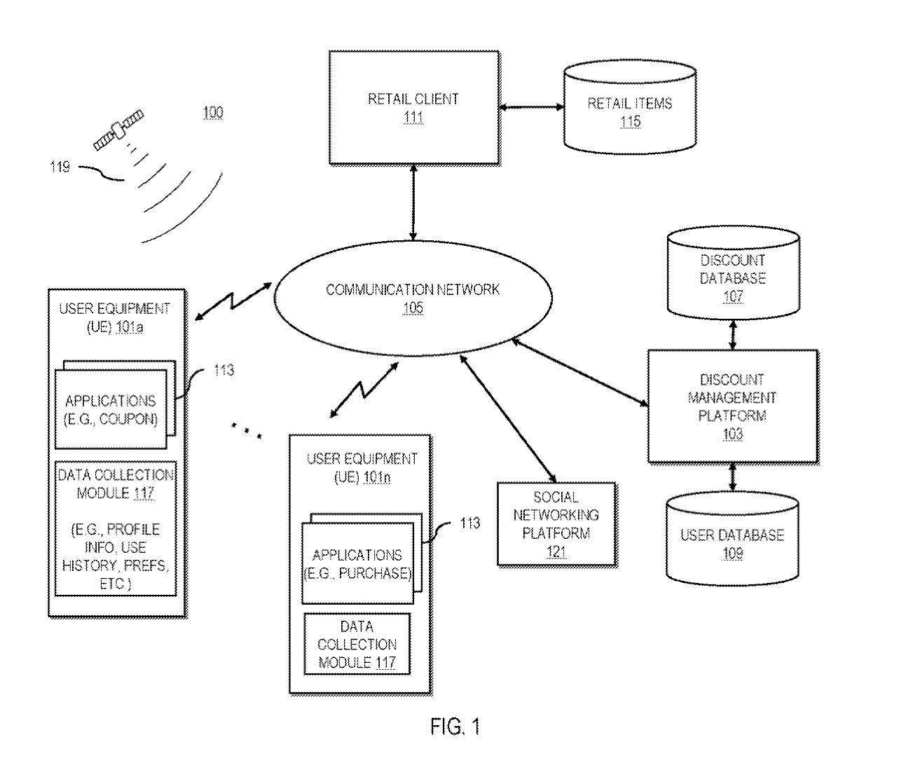

FIG. 1 is a diagram of a system capable of providing template-based discount valuation and ranking, according to one embodiment. Modern electronic commerce services are rapidly being deployed and gaining wide acceptance among users (e.g., online shopping service). As a result, one area of interest for service providers and device manufacturers has been how to offer the best economic value to consumer (e.g., the best deal, coupons or discount offers, etc.). However, as previously discussed, discount providers (e.g., retailers, sellers, etc.) often provide such promotions or discounts in a variety of forms with varying terms and conditions, thereby making it difficult for consumers and services to efficiently process and calculate the respective values of the offers. For example, promotions may include: “On sale—30% Off”; “$50 off the first $200 spent”; “Buy a television and get a free book”; “10% off for one item and 20% off for two items”; etc.

Historically, much this discount information (e.g., coupon information) has been hard to process by machine because: (1) lack of formal semantic representation for presenting discount or coupon information; (2) lack of a common measure for calculating discounts; (3) difficulty to personalize discount values for a particular user; (4) lack of dependency analysis for determine value of non-monetary offers such as “buy a camera and get a tripod” versus “buy a camera and get a memory card”; and the like. For example, the perceived value of a discount offer can vary according to personal desire, user preferences, and other information related to a particular user.

To address this problem, a system 100 of FIG. 1 introduces the capability to provide a template-based method for representing discount information. In one embodiment, when customers and/or sellers provide or otherwise specify discount information, they can choose a template (e.g., a discount template) and fill the predefined text input fields of template according to a common discount vocabulary. As used herein, the term “vocabulary” refers to a set of semantic tags used for defining or specifying one or more parameters of discount information. In this way, the template can standardize the entry of the parameters or details of the discount information. Moreover, the standardization of the input fields also facilitates processing and or calculation of the benefit or value of the discount. For example, if a seller provides discount information (e.g., via a coupon) such as “Save $50 after $200”, then the seller can choose a template that expresses the discount as “exceed $X save $Y” where X and Y are blank where deal creators can input specific numbers. In this case, the seller can fill the X and Y with $200 and $50. In various embodiments, the templates also include predetermined discount calculating equations or functions for efficiently calculating the discount value. For example, the equations can be used to calculate: (1) a latent maximum discount rate (MD) which represents the maximum available discount if all parts or conditions of the offer are met; and (2) an actual discount rate of the current deal (CD) which represents the value of the discount based on currently satisfied conditions or terms.

In this way, different goods with different discounts or discount types can be valued according to the discount valuation framework of the system 100. In one embodiment, the values can then be used to rank or compare the various discounts. For example, in one embodiment, a valuation function (e.g., f(P, MD, CD) where P denotes the original price, MD is the latent maximum discount rate, and CD is the current discount) is used to compare the discount values of the different goods and offered discounts. In one use case, for instance, the system 100 can compare the discount values between a discount or coupon for 10% off a television and a discount for 30% off a book.

In embodiment, the rankings of the template-based discounts can then be used to provide recommendations to the user, which is particularly important for mobile devices where the typical display area for presenting discount information is limited.

In one use case, a consumer can use various embodiments of the approach described herein as discount calculation tool by enabling users to quickly enter parameters of a discount offer into an appropriate template and then calculate the discount value. Historically, it has often been difficult or not be obvious what the actual value of a discount is.

Other uses of the discount template include enabling the user to keep records of deals or offers encountered over a period of time. The values of these deals or discount offers can then be calculated to enable the user to quickly compare the offers when the user is ready to select a deal.

In yet another embodiment, the discount templates enable the user to quickly specify personal criteria and/or preferences for selecting among various discount offers.

In summary, under various embodiments of the system 100, users are able to input their needs, preferences, etc. to get discount information. In addition, if a user finds new discount information (e.g., a new type of discount with different combinations or applications of one or more discount parameters), the user can choose to fill out a discount template for uploading to a server. If no template exists, the user can create a new template according to a predetermined vocabulary. Moreover, a user can obtain calculations of the discount values for comparing and/or ranking discount information.

With respect to discount providers, such providers can choose a template to provide discount information to potential customers. If the discount provider does not know or need assistance choosing a template, the system 100 can recommend the most popular and/or effective discount template for a given item.

As shown in FIG. 1, user equipment (UEs) 101a-101n (also collectively referred to as UEs 101) can connect to a discount management platform 103 over a communication network 105 to utilize group purchasing services. In this example, the UEs 101a-101n can be associated with one or more consumers searching for or otherwise accessing discount information. Moreover, the discount management platform 103 can retrieve discount templates and/or discount information from a discount database 107 and user context information, profile information, preferences, etc. from the user database 109 for customizing the discount information and/or the determination of the discount values associated with the discount information. In other words, the databases 107 and 109 may be utilized to provide the template-based discount valuation services to the UEs 101 and/or a retail client 111. In one embodiment, the UEs 101 can use an application 113 (e.g., a coupon application) to request and/or specify discount information about a particular item to the discount management platform 103.

In certain examples, the retail client 111 can be a UE 101 operated by a discount provider (e.g., a retailer or seller) to specify discount information. For example, a retail client 111 and/or UE 101 can be utilized to upload information about retail items 115 (e.g., retail items 115 associated with a retail store, other purchasable items such as goods and/or services, etc.) and related discount information to the discount management platform 103. In this manner, discount information and/or discount templates can be transmitted to the discount database 107 of the discount management platform 103. In certain embodiments, the discount information and/or templates may be defined and/or stored locally by the retail client 111 and/or UE 101 in, for instance, the retail items database 115.

In one embodiment, the system 100 determines or otherwise specifies a common vocabulary for representing discount information within the system 100. In one embodiment, the common vocabulary provides a basis for a formal or uniform representation of the discount information to reduce the potential for semantic ambiguity of various discount expressions (e.g., the meaning of “30% off” versus “Up to 30% off” versus “At least 30% off”). As noted previously, the common vocabulary also facilitates the calculation and/or ranking of discount offers, coupons, etc. for more efficient selection or use by consumers. For example, a discount provider can choose from among predetermined templates created to reflect different discount types based on the vocabulary. In one embodiment, if there is not suitable template, the deal provider can define a new template based on the vocabulary for subsequent use and/or sharing with other users.

In one embodiment, the system 100 provides a unified measure of the values of various discount offers based on the discount templates. For example, a discount template may include equations for calculating discount values. By way of example, one equation may be used to calculate the latent maximum discount (MD) and another equation can be used to calculate a discount rate of the current deal (CD). In one embodiment, the results of the discount value calculations can be used to rank the various deals. In yet another embodiment, the equations may be directed to calculating a discount value based on the economic value of the discount as well as the semantic value (e.g., relevant to the interests, context, preferences, etc. of the user). Moreover, the relative contributions of the economic value and semantic value components of the overall discount value can be adjusted according to one or more respective weight values.

In one embodiment, the semantic value may also reflect a subjective value of the discount offer to a particular user. For example, in many situations, a numerical or strictly economic comparison can be bounded by the subjective considerations based, at least in part, on personal preference as well as shopping intention. For instance, an example user may prefer discounts based on a percentage off over other types of discounts (e.g., buy one get another free). In yet another embodiment, the same user may have a hierarchy of preferred discounts. In one example, for combination offers (e.g., buy an item and get a related item for free), the user may prefer certain items over others even if the non-preferred item has more economic value. For instance, the user may prefer an offer such as “buy a camera and get a 16 GB memory card free” over “buy a camera and get a tripod free” because the user already has a tripod even the tripod may be more expensive than the 16 GB memory card. In this case, the memory card has more semantic value than that tripod to the user even though the economic value is less.

In one embodiment, the semantic value may be determined either implicitly or explicitly. For example, implicit determination of semantic value may be based on user preferences, interests, profile information, community preferences, etc. that are derived from data mining or other semantic analysis techniques. On the other hand, explicit determination of semantic value may be specified directly by the user (e.g., as a list of desired items).

In yet another embodiment, users may request recommended discounts by inputting needs, desires, preferences, etc. in one or more of the templates for evaluation by the system 100. For example, a user may enter desired characteristics or criteria associated in the input fields of the template which are then matched by the system 100 to currently available discounts. In one embodiment, discount information may be provided or retrieved using a publish/subscribe function, whereby discount providers publish discount information via the templates and consumers subscribe discount information by specifying or inputting criteria via the templates.

In another embodiment, the system 100 can track information on the popularity of one or more of the templates for specific types of discount information. Based on the popularity, the system 100 can recommend one or more templates to discount providers to reflect the discount types that are most popular to users. In another embodiment, the system 100 can track a correlation between the effectiveness of certain templates or discounts types (e.g., by monitoring the click through rates of specific templates and discounts) in generating sales, user interest, queries, etc. and then recommend the templates to discount providers based on the correlation.

As shown, the user database 109 may include user profiles associating each user with profile information, discount use history, context information, discount subscription information, etc. for use by the system 100. These user profiles may be linked to an account of the user. In certain embodiments, the information in the user database 109 may dynamically change over time. For example, user preferences, criteria (e.g., item wish lists), etc. can change over time and affect the valuation, ranking, and/or selection of discount information by the user.

In one embodiment, subscription information may include one or more parameters utilized to determine the relevancy of published discount information and/or templates to individual users. Such parameters can include categories or types of the discounts that the user indicates the user may wish to receive. For example, categories or characteristics for discount information can include types of goods (e.g., furniture, home and garden, bed and bath, clothing, shoes, accessories, electronics, sports, books, media, etc.) as well as subcategories of such goods (e.g., electronics may include computers, video games, cameras, portable media players, navigation equipment, cell phones, etc.), types or amounts of discounts, validity periods of the discounts, discount value (e.g., economic and/or semantic value), and the like.

The discount database 107 may include information about one or more items (e.g., retail items) and associated discount information (e.g., discount values and rankings). For example, the item database 109 may include categorical information associated with the items (e.g., products, services, etc.) The categorical information may be stored in a data structure (e.g., a tree) and include one or more subcategories. Further, the item database 109 can include a description of any discounts, coupons, promotions, etc. associated with one or more items of the database.

Profile information, discount use history, preferences, discount criteria, etc. as well as context information about a user, the UE 101, or a combination thereof can be collected and monitored at the discount management platform 103 or the UE 101. In certain embodiments, an application 113 on the UE 101 can monitor the information associated with a data collection module 117 of the UE 101. For example, the data collection module 117 may utilize applications, services, sensors, etc. to collect such information. For example, the data collection module 117 may have connectivity to a location determination sensor system, such as a Global Positioning System (GPS) to access GPS satellites 119 to determine context information (e.g., the location of the UE 101). The UE 101 may then cause transmission of the collected information (e.g., the profile information, discount use history, preferences, context information, etc.) to the discount management platform 103 for processing discount to determine discounts and values. In one embodiment, the discount management platform 103 can receive and store the information in a user profile associated with the user in the user database 109. In certain embodiments, the user profile may include an identifier of the user (e.g., a username) and/or an identifier of the UE 101 (e.g., a hardware identifier such as an International Mobile Equipment Identity (IMEI), a phone number, an Internet Protocol address, etc.).

In one embodiment, received criteria associated with the discount information and/or templates can be used to determine which users should receive send discount reminder notifications. The criteria can include one or more parameters or rules about or for processing the discount information and/or user information associated with the users. In another example, the user may be associated one or more social networks on one or more social networking platforms 121 for sharing of discount information and/or rankings of one or more discount items. Examples of social networking services include networks in which users can interact with other users. In certain examples, user may update profiles to interact and share discount information with others. Information associated with the social networking platform 121 may be utilized as criteria for determining and/or filtering discount information, discount valuations, discount rankings, and related information. In certain embodiments, the discount management platform 103 can contact the social networking platform 121 (e.g., via an application programming interface) to retrieve social networking information utilized as criteria parameters for template-based discount valuation and/or ranking.

Moreover, the users (e.g., subscription discount users) can set criteria that can be stored in the user profiles. As previously noted, such criteria can include selected relevant categories of discount information, rankings, and/or values. Further, the criteria can include subscription information about proximity of the subscription user to the discounted items, promotions, etc. For example, the subscription user can set a user profile parameter so that the user only gets notifications of discount information or values if defined criteria are met.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, discount management platform 103, and retail client 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the discount management platform 103 may interact according to a client-server model with the applications 113 of the UE 101. According to the client-server model, a client process sends a message including a request to a server process, and the server process responds by providing a service (e.g., group organization, group purchasing, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

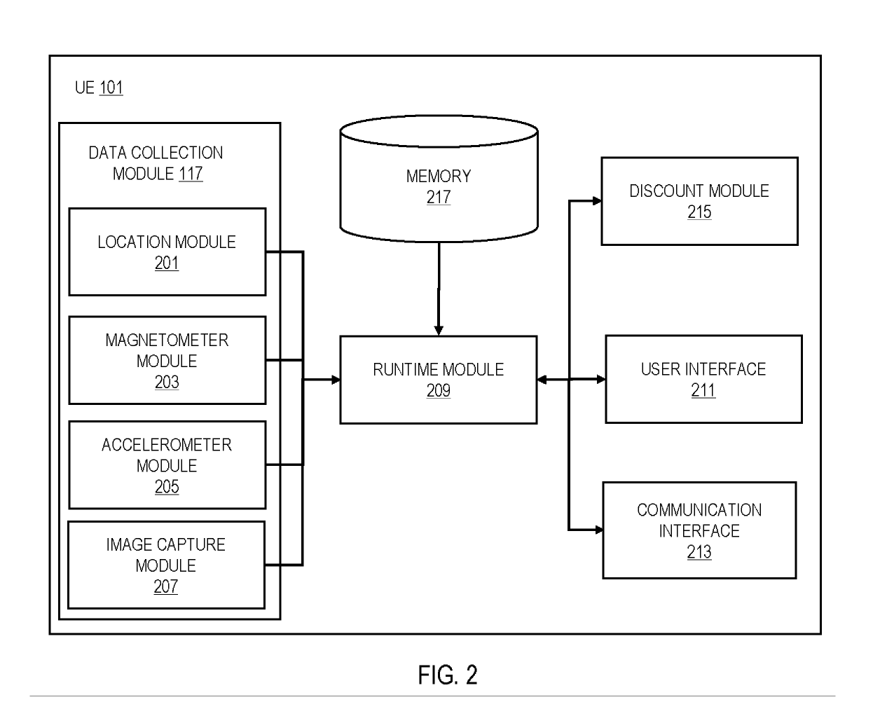

FIG. 2 is a diagram of the components of user equipment capable of template-based discount valuation and ranking, according to one embodiment. By way of example, a UE 101 includes one or more components for providing template-based discount valuation and ranking. It is contemplated that the functions of these components may be combined in one or more components or performed by other components of equivalent functionality. Moreover, the functions and/or the components may be resident locally at a client device (e.g., the UE 101) and/or be located remotely over the communication network 105 (e.g., a server, cloud-based computing component, etc.). In this embodiment, the UE 101 includes a data collection module 117 for collecting implicit and/or explicit user profile information for determining discount values and rankings. As noted previously, user profile information may be used to determine the semantic value of one or more discounts, templates, etc. to a particular user. For example, the data collection module 117 may collect and/or determine information such as transaction records, discount use history, item views, item searches, results from recommendation engines, prior recommendations and/or user ratings, and the like to infer or calculate discount information including identifying products, items, and/or related discount information of potential interest to the user.

In another embodiment, the data collection module 117 may record or receive input for specifying discount information, products, items, etc. explicitly. For example, the user may generate one or more lists of products and/or discounts of interest. In some embodiments, the lists may be divided based on various criteria. For instance, the user may maintain a list of essential or needed items and another wish list of items that the user would like to have but are not essential. In this way, the lists or explicit user profile information may be used to define discount information of interest and their respective priorities relative to a particular user.

In another embodiment, the data collection may include or otherwise have access to context sensors for determining context information about the UE 101 and/or the user. The context information may, in some embodiments, be used to further personalize the discount valuations and/or rankings. For example, a smaller discount offer associated with a nearby location may be ranked more highly that a larger discount offer at a further location depending on user preferences and interests. Accordingly, the data collection module 117 of the UE 101 may include or have access to one or more location modules 201, magnetometer modules 203, accelerometer modules 205, and image capture modules 207 for capturing such context data.

The location module 201 can determine a user's location. The user's location can be determined by a triangulation system such as GPS, assisted GPS (A-GPS), Cell of Origin, or other location extrapolation technologies. Standard GPS and A-GPS systems can use satellites 119 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are transmitted to the discount management platform 103 via the communication interface 213. Moreover, in certain embodiments, the GPS coordinates can include an altitude to provide a height. In other embodiments, the altitude can be determined using another type of altimeter. Further, the location module 201 can utilize wireless local area networking location sensing technologies and/or other types of indoor location technologies to determine locations. With this approach, users' locations within buildings can be sensed.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of an image capture device (e.g., a camera) can be marked as a reference point in determining direction. The image capture device can provide image information from a sensor to the image capture module 207. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217 and/or transmitted via the communication interface 213 to the discount management platform 103. This may be utilized to determine where a traveling user is going. For example, if the user is traveling away from a group event at a certain speed (e.g., determined by location information as well as directional information), the discount management platform 103 may determine not to send a notification of the group event to the user.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of the image capture device can be marked as a reference point in determining direction. Because the acceleration due to gravity is known, when a UE 101 is stationary, the accelerometer module 205 can determine the angle the UE 101 is pointed as compared to Earth's gravity. In one embodiment, vertical directional data obtained from an accelerometer is embedded into the metadata of captured or streaming media or otherwise associated with the UE 101 by the purchase application 113. In certain embodiments, the magnetometer module 203 and accelerometer module 205 can be means for ascertaining a perspective of a user. This perspective information may be stored in the memory 217 and sent to the discount management platform 103. Further, because the Earth's gravity is known, the accelerometer module 205 may be utilized as a base point for determining magnetometer information.

Moreover, the image capture module 207 can capture still images and/or video from an image sensor. Further, audio information may be retrieved from a microphone input source associated with the UE 101. The image capture module 207 can be utilized to capture images, video, and/or media associated with one or more items and their accompanying discount information for valuation and ranking. By way of example, the image capture module 207 can be used to capture an image of a sign or coupon presenting discount information. This discount information can then be recognized and parsed from the captured image and used to populate one or more templates for valuation and/or ranking. In another embodiment, the discount information may be associated with one or more barcodes that can be read from the image. In yet another embodiment, instead of or in addition to the image capture module 207, the data collection module include or have access to a near field communication (NFC) or radio frequency identification (RFID) tag for acquiring discount information. In one embodiment, the image or other captured discount information may be processed locally at the device. In addition or alternatively, the captured information can be transmitted to the discount management platform 103 for processing, valuation, and/or ranking.

As shown, the UE 101 can also include a runtime module 209 to coordinate the use of other components of the UE 101, a user interface 211, a communication interface 213, a discount module 215, and memory 217. An application 113 (e.g., a discount application) of the UE 101 can execute on the runtime module 209 utilizing the components of the UE 101.

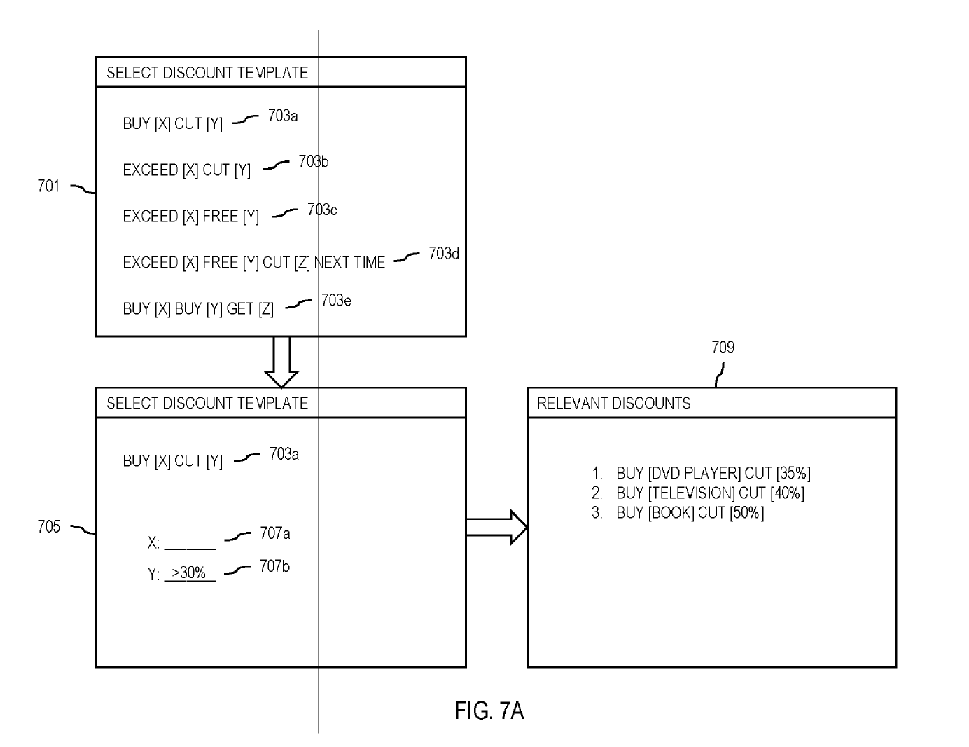

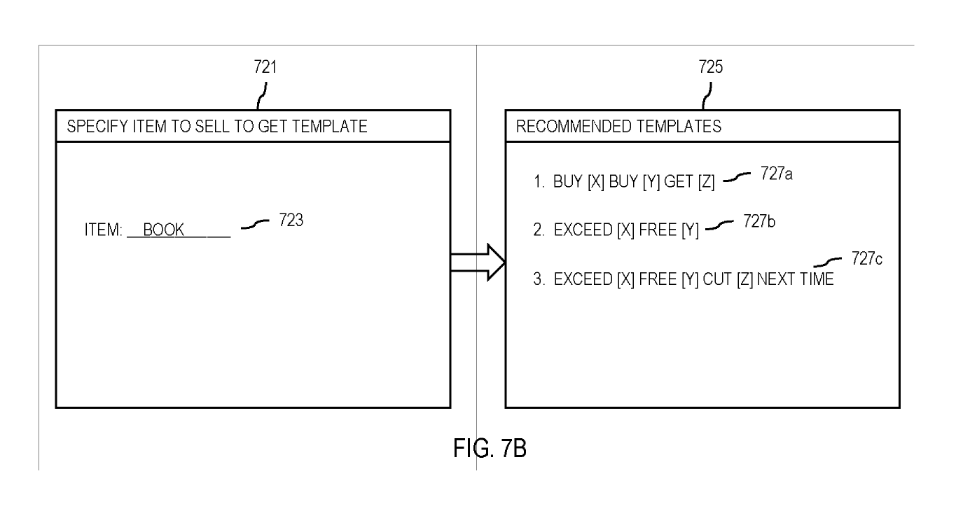

In one embodiment, the user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. In certain embodiments, the user interface 211 and/or runtime module 209 can be means for causing presentation of template-based discount information and associated values and/or rankings. Example user interfaces are shown in FIGS. 7A and 7B below.

In one embodiment, the communication interface 213 can be used to communicate with the discount management platform 103, the retail client 111, and/or other UEs 101. Certain communications can be via methods such as an internet protocol, messaging (e.g., Short Message Service (SMS), Multimedia Messaging Service (MMS), etc.), or any other communication method (e.g., via the communication network 105).

The discount module 215 may be utilized in facilitating access to template-based discount information, values, and/or rankings associated with the UE 101, the retail client 111, and/or the discount management platform 103. In embodiment, the discount module 215 can thus be utilized to collect user profile information, context information, preferences, etc. associated with determining template-based discount values and/or rankings. Further, the discount module 215 can be utilized in notifying a user of available discount information, conditions for using a discount, discount values, discount rankings, and the like. In one embodiment, the discount module 215 performs all or a portion of the functions described with respect to the discount management platform 103.

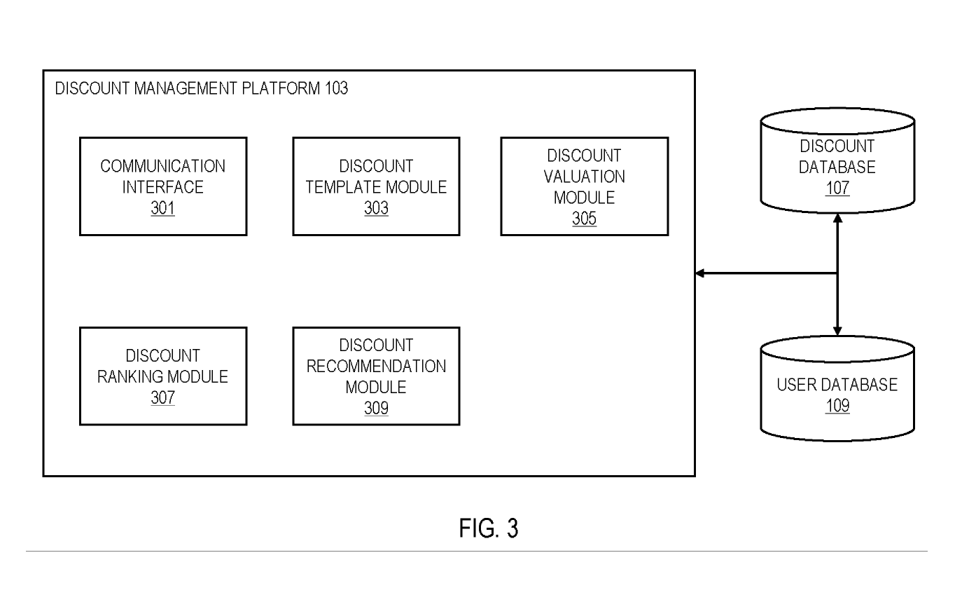

FIG. 3 is a diagram of the components of a discount management platform, according to one embodiment. By way of example, the discount management platform 103 includes one or more components for providing template-based discount valuation and ranking. It is contemplated that the functions of these components may be combined in one or more components or performed by other components of equivalent functionality (e.g., the discount module 215). In this embodiment, the discount management platform 103 includes a communication interface 301, a discount template module 303, a discount valuation module 305, a discount ranking module 307, a discount recommendation module 309, and a memory 311. As noted previously, it is contemplated that all or a portion of the functions of the discount management platform 103 may be performed by the discount module 215 of the UE 101.

In one embodiment, the communication interface 301 can be used to communicate with a UE 101 as well as other devices connected on the communication network 105. In one embodiment, the discount management platform 103 can receive discount information, user-specified templates, user profile information, user and the like from the UE 101 via the communication interface 301 via methods such as internet protocol, MMS, SMS, GPRS, or any other available communication method. By way of example, the UE 101 may further send discount and related information to the discount management platform 103 to access template-based discount valuation and ranking functions, such as to determine available templates, calculate discount values, update user profiles in the user database 109, specify and/or share discount information in the discount database 107, etc.

In one embodiment, the discount template module 303 provides a framework for generating templates for expressing different types of discounts. More specifically, the discount template module 303 can specify a vocabulary (e.g., a set of common words, functions, operations, etc.) for describing one or more parameters of the discount information (e.g., amount of discount, category of discount items, terms of the discount, etc.). In one embodiment, the vocabulary can be predetermined by one or more service providers and/or device manufacturers. In addition, the vocabulary can be extensible users, discount providers, service providers, and the like to reflect new discount parameters, terms, and/or conditions. In one embodiment, the vocabulary is used to define the labels, input fields, calculations (e.g., equations, value functions, etc.) for determining discount values (e.g., economic and semantic values), and the like.

In one embodiment, the discount template module 303 also populates or receives input for populating the one or more templates with one or more parameters determined from discount information associated with one or more retail clients 111 and/or one or more items offered by the retail clients 111. The discount templates and/or populated discount information may be stored in the discount database 107. Based, at least in part, on the discount information defined in the templates of the discount template module 303, the discount valuation module 305 calculates the corresponding discount values. As previously noted, the discount values may be include both an economic component (e.g., a calculation of the economic value of the discount) and a semantic value (e.g., a value of the discount based on user profile information). It is contemplated that the discount valuation module 305 may apply different weight values to the economic and semantic values to derive at an overall discount value.

In one embodiment, the discount valuation module 305 can calculate the discount values in real time as a user shops. For example, if a discount template is based on contingent terms (e.g., get a free DVD for spending $100; and a toaster for spending $125), the can calculate when a user reaches the different threshold values to satisfy the terms and alerts the user accordingly. For instance, if the user has already spent $120, the discount valuation module 305 can perform discount value calculations to notify the user that if the user spends another $5, the user will receive a toaster.

In certain embodiments, the discount valuation module 305 may determine the discount values of discount information associated with multiple items. The items can then be ranked based on their respective values for recommendation to the user by the discount ranking module 307. By way of example, the discount ranking module 307 may rank the items based on, for instance, the overall discount value, the economic value, the semantic value, or a combination thereof.

In one embodiment, based on the ranking information, the discount recommendation module 309 can generate one or more recommendations to the user, discount providers, retailers, etc. regarding one or more of the discount templates or types. For example, for users, the discount recommendation module 309 can recommend discounts or templates based, at least in part, on the user's history, preferences, etc. Similarly, for discount providers, the discount recommendation module 309 can provide market analytics for determining, for instance, popular or effective discount templates, the best level of discount to offer for a given product, and the like. In one embodiment, the recommendations may be pushed to the users based, at least in part, on user preferences, history, context, etc.

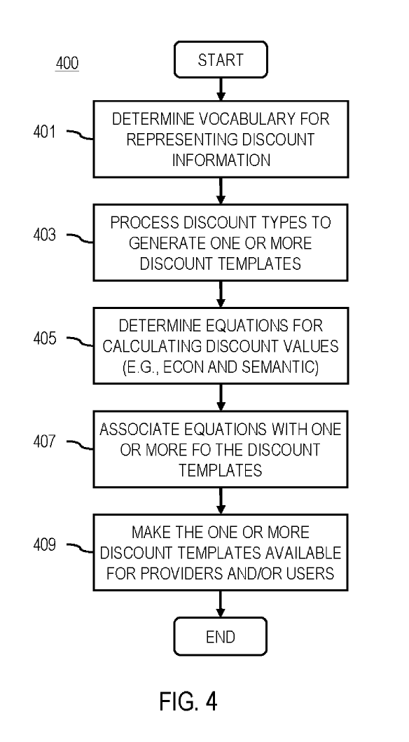

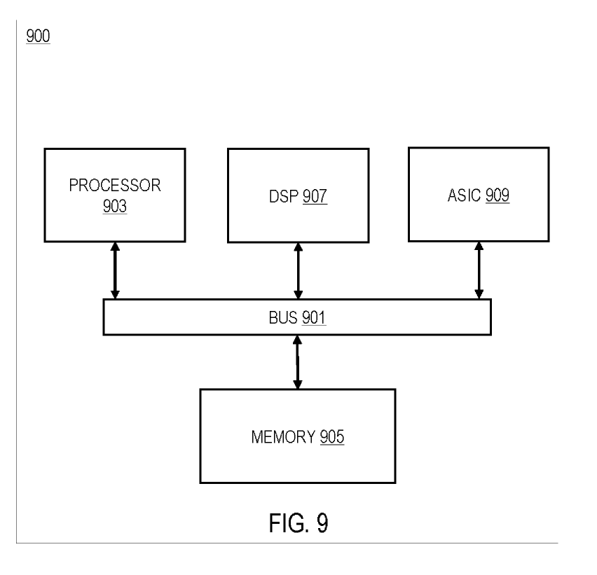

FIG. 4 is a flowchart of a process for creating discount templates, according to one embodiment. In one embodiment, the discount management platform 103 performs the process 400 and is implemented in, for instance, a chip set including a processor and a memory as shown in FIG. 9. Additionally or alternatively, the discount module 215 of the UE 101 may perform one or more aspects of the process 400.

At step 401, the discount management platform 103 determines a vocabulary for representing discount information associated with one or more discount types. In one embodiment, the vocabulary is part of a set of rules for defining templates. For example, the rules may include: (1) the template consists of labels and input text fields, (2) the labels and fields are chosen from the predefined vocabulary, and (3) the text input fields can contain two kinds of texts: condition text and benefit text. In one embodiment, the context test describes the conditions or terms for getting the discount and the benefit text describes the benefit of the discount. For example, in the discount information “buy X get Y”, x is the condition text and y is the benefit text. Examples of terms defined in a typical vocabulary include: buy, get, free, cut, return. These terms can then be used to define a discount (e.g., buy (TV) cut (20%) get (movie DVD)).

The discount management platform 103 then causes, at least in part, processing of the one or more discount types to generate one or more templates based, at least in part, on the vocabulary (step 403). In one embodiment, the one or more templates include, at least in part, one or more labels, one or more input fields, or a combination thereof for calculating one or more discount values associated with the discount information. As previously noted, the one or more discount values include, at least in part, an economic value, a semantic value, or a combination thereof.

At step 405, the discount management platform 103 determines at least one equation for calculating the one or more discount values based, at least in part, on data associated with the one or more input fields of the discount templates. In one embodiment, the at least one equation normalizes the one or more discount values across the one or more discount types. In certain embodiments, the at least one equation is also for calculating, at least in part, an original price, a maximum discount value, a current discount value, or a combination thereof. The discount management platform 103 then causes, at least in part, an association of the at least one equation with the one or more templates (step 407).

In one embodiment, as previously described, the templates include equations for determining at least a latent maximum discount (MD) and a current deal (CD). It is contemplated that the equations for MD and CD can be different for each template depending on the structure of the discount (e.g., 10% off purchases over $100 vs. Buy 2 items get 1 free).

The following are example, equations for two different discount types. For one example discount type, the discount provider specifies that a consumer will receive $10 off a purchase over $100. This offer, when written in standard vocabulary template form, can be expressed as: Exceed $X Free $Y, where X represents the amount to spend (e.g., $100) to get the discount Y (e.g., $10). In this example, the MD and CD equations may be defined as:

$$MD = \frac{X - Y}{X}$$

$$CD = \frac{P - ⌊ \frac{P}{X} ⌋ \cdot Y}{P} ,$$

where P=Original Price.

For another example discount type, the discount provider is offering a $25 dollar coupon for a next purchase of over $100 for spending $100 now. The corresponding discount template can be expressed as: Exceed $X Return Coupon $Y For Exceeding $Z Next Time, where X (e.g., $100) is the amount to spend now to get a coupon for amount Y (e.g., $25) for spending Z (e.g., $100) next time. In this case, the MD and CD equations may be defined as:

$$MD = \frac{X + Y - Z}{X + Y}$$

$$CD = 1$$

In this example, CD is equal to one because no discount is provided for in the current offer. The offer is for a discount on a subsequent purchase. It is noted that the equations for the two discount types are normalized to facilitate comparison and/or ranking.

Then, the discount management platform 103 makes the one or more discount templates available for discount providers and/or users (step 409). In this way, when a user or discount provider wishes to access or provide discount information, the user or provider can choose from among the templates and fill in the appropriate discount information. If there is no suitable template available, the user or provider may search over the communication network 105 for a suitable template. In one embodiment, the user may create a new template using the vocabulary or simply add free text to an existing template. The free text can then be parsed (e.g., via natural language processing) to generate a new template.

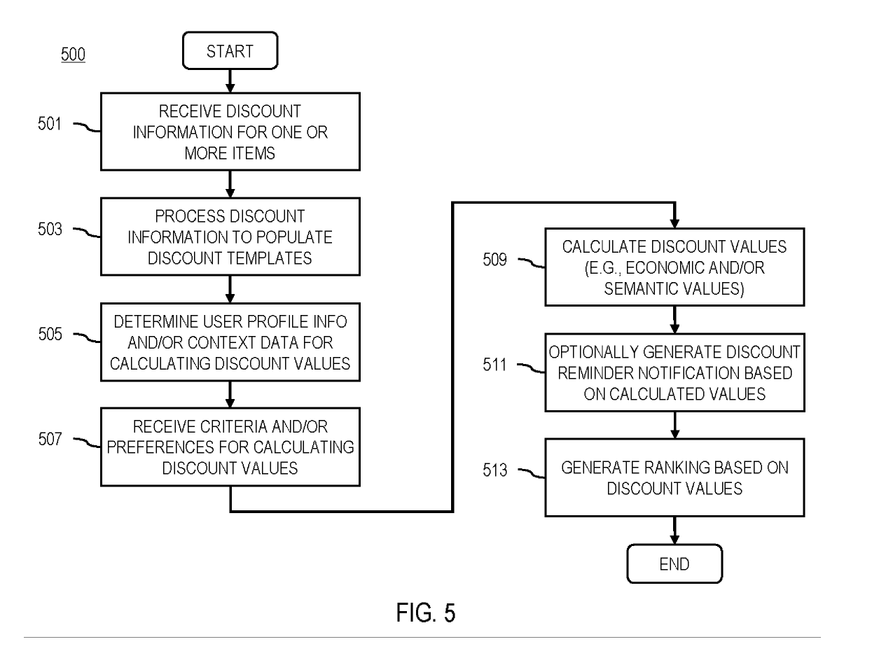

FIG. 5 is a flowchart of a process for populating discount templates and ranking discount offers, according to one embodiment. In one embodiment, the discount management platform 103 performs the process 500 and is implemented in, for instance, a chip set including a processor and a memory as shown in FIG. 9. Additionally or alternatively, the discount module 215 of the UE 101 may perform one or more aspects of the process 500.

At step 501, the discount management platform 103 receives discount information for one or more items. The discount management platform 103 then causes, at least in part, processing of the discount information to populate at least a portion of the one or more templates (step 503). In one embodiment, the receiving of the discount information for the one or more items includes, at least in part, causing at least in part capture of the discount information via sampling and recognition, reading of a bar code, reading of a near field communication tag, reading of a radio frequency identification tag, or a combination thereof. In other words, a user may attempt to photograph or otherwise read the discount information so that the user will not be asked to manually enter the discount information.

At step 505, the discount management platform 103 determines profile information, context data, or a combination thereof associated with at least one user for use in calculating discount values associated with the discount information. As previously noted, the profile information may be determined implicitly, explicitly, or a combination thereof. At step 507, the discount management platform 103 also receives an input from at least one user for specifying one or more criteria, one or more preferences, or a combination thereof.

In one embodiment, based on the profile information, context data, criteria, and/or preferences, the discount management platform 103 causes, at least in part, processing of the discount information based, at least in part, on the one or more equations of the populated one or more templates to generate respective discount values for the one or more items (step 509). As discussed above, the discount values can be based, at least in part, an economic value of the discount and a semantic value of the discount. In this case, the discount management platform 103 can also determine a first weight value of the economic value and a second weight value of the semantic value to generate an overall discount that balances the economic and semantic components. For example, the weight values may be shifted so that the resulting ranking of the discounts or items matches user selection preferences. In other words, the discount management platform 103 can monitor whether a particular user selects the most highly ranked items or lower ranked items. If the user regularly selects the lower ranked items, the discount management platform 103 can adjust the weight values so that the ranking of the items more closely matches the user selections.

In one embodiment, the discount management platform 103 can cause, at least in part, processing of the respective discount values to generate a reminder notification regarding the one or more discounts (step 511). In one embodiment, the reminder notification includes, at least in part, an estimate of at least one of the respective discount values.

At step 513, the discount management platform 103 causing, at least in part, processing of the respective discount values to generate a ranking the one or more of items based, at least in part, on the respective values of the one or more discounts. In one embodiment, the ranking can be based on the MD and CD equations associated with the templates using a uniform criterion f(P, MD, CD) based on a ranking function Rank(x) as follows:

$$f ( P , MD , CD ) = \frac{Rank {( P \cdot ( 1 - MD ) )}^{{w}_{1}}}{{( MD \cdot CD )}^{{w}_{2}}}$$

$$Rank ( x ) = \{ \begin{matrix}1 , & x ∈ [ 0 , 10 ) \\ 2 , & x ∈ [ 10 , 100 ) \\ 3 , & x ∈ [ 100 , 1000 ) \\ 4 , & x ∈ [ 1000 , 10000 ) \\ 5 , & x ∈ [ 10000 , 100000 )\end{matrix}$$

where w₁=first weight value, w₂=second weight value.

In one use case, a user wishes to compare a first offer (e.g., Buy $10000 television and get 10% off) against a second (e.g., Buy $100 book and get free 30%). In this case, the criterion (f(P, MD, CD)) is evaluated for each offer to result in respectively f(10000, 0.9, 0.9) and f(100, 0.7, 0.7). When processed through the function Rank(x), f(1000, 0.9, 0.9)>f(100, 0.7, 0.7), so that the first offer is a better deal based on the calculated discount values.

In another embodiment, a user who is looking for coupons or discount offers can submit criteria such as a discount range. The discount management platform 103 can then search for offers matching the criteria and rank the results based on the criterion f(P, MD, CD) and/or the ranking function Rank(x).

In one embodiment, calculated economic or numeric values for discount information may be supplemented by subjective or semantic values. By way of example, the semantic value can depend of personal preference, user profile information, shopping intention, etc. For example, a user may personally like “X % off” discount types better than other discounts. However, if the user sees a combination deal such as “buy a camera and get a 16 GB memory card free”, the user might take the deal because the user needs a memory card. In contrast, if the deal is “buy a camera and get a tri-pod free”, then the user may pass because the user does not need a tri-pod. However, this could be a better offer for another user who needs a tri-pod versus a memory card. In this example, the tri-pod probably is more expensive than the memory card, so the second deal is more relevant than the first deal based on economic value. But when factoring in the semantic value (e.g., based on user preference for particular items), the first deal is more relevant to the user because the user needs or wants a memory card rather than a tri-pod.

Accordingly, in one embodiment, for determining discount values, the discount management platform 103 combines user profile information (e.g., preferences, wish lists, etc.) and a data mining approach (e.g., predict user interests based on user behavior) to estimate a semantic value to generate personalized relevancy values. For example, the semantic value may be based on personal context of the user such as user profile information. In this case, the user can explicitly specify preferences and/or wish lists. In addition, the discount management platform 103 can mine, for instance, the user's shopping preferences and histories.

In another embodiment, the semantic values may be based on general semantic dependencies by, for instance, mining frequent shopping item co-occurency from shopping log data (e.g., milk is always purchased with cereal). Moreover, the discount management platform 103 can also use data mining methods to determine frequent patterns or correlations of items and discount types or offers. For example, data mining may show that more users buy cameras with memory cards than with tri-pods.

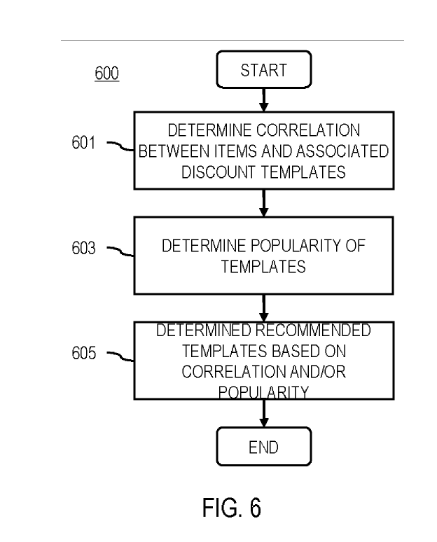

FIG. 6 is a flowchart of a process for determining recommended discount templates, according to one embodiment. In one embodiment, the discount management platform 103 performs the process 600 and is implemented in, for instance, a chip set including a processor and a memory as shown in FIG. 9. Additionally or alternatively, the discount module 215 of the UE 101 may perform one or more aspects of the process 600.

At step 601, the discount management platform 103 determines a correlation between the one or more items and the one or more templates. The discount management platform 103 also can determine popularity information of the one or more templates with respect to one or more discount providers, one or more discount consumers, or a combination thereof (step 603).

The discount management platform 103 can then cause, at least in part, processing of at least the correlation, the popularity information, or a combination thereof to determine one or more recommended templates (step 605). For example, for a case like “buy X get Y”, the discount management platform 103 can determine with the (X, Y) is a frequent pattern and whether Y is in the user's profile information. If so, the discount management platform 103 can give this discount information a high priority for recommendation and/or ranking.

In one embodiment, a user may request a discount my using the discount templates to specify preferences, criteria, needs, wishes, etc. The discount management platform 103 will then determine appropriate discount information based, at least in part, on the information entered in the templates.

In another embodiment, discount providers and/or sellers may want to use predefined templates to provide discount information to their customers, but the providers or sellers may be confused as to which template is best or most popular. In this case, the discount management platform 103 can recommend the most popular or effective templates. For example, the discount management platform 103 can store and track click-through rates or other indicators of popularity with respect to the discount templates and corresponding items.

In one use case, a seller wants to sell a television set and wants to know which promotion or discount strategy is the most popular. The seller can specify criteria related to the television set and request a recommendation. The discount management platform 103 returns, for instance, a recommendation that the template “buy X cut Y get Z” is most popular. Accordingly, the seller decides to offer the following discount: “buy [television] cut [20%] get [book]”.

FIGS. 7A and 7B are diagrams of user interfaces utilized in the processes of FIGS. 4-6, according to various embodiments. FIG. 5A shows a user interface (UI) 701 for specifying from among a selection of available discount templates to initiate a search of available discount information. As shown, in the UI 701 presents five templates (e.g., discount templates 703a-703e) that are specified according to a predetermined vocabulary. In this example, the user selects discount template 703a and is presented with UI 705 for specifying criteria to initiate a search based on the selected discount template 703a.

The UI 705 presents two input fields 707a and 707b corresponding to the parameters defined in the template 703a. In this example, the user enters a condition in input field 707b for selecting discount information that provides for greater than 30% discount according to the specified template.

The UE 709 presents a list of discount information that meet the user's conditions and that are specified according to the selected template 703a. In this example, the list is ranked according to a calculated discount values calculated to include both economic and semantic value to the user. For example, the discount for a DVD player at 35% off is calculated to be economically less than a 40% discount on a television, because the user in this example has specified that he needs a DVD player but does not need a television. Accordingly, the DVD player discount is of more semantic relevance to the user.

FIG. 7B shows a user interface 721 for specifying one or more items to request a template recommendation from the discount management platform 103. More specifically, in this example, a discount provider or seller would recommendations on what types or discounts or promotions are most popular for selling a book. In this case seller inputs “book” into the text input field 723. Based on this input, the discount management platform 103 generates a list of recommended templates 727a-727c based on, for instance, their popularity with other book sellers.

The UI 725 then presents the list. In this case, the most popular template for selling books is a buy two books get another item free offer. This offer is expressed in the discount template 727a as “buy X buy Y get Z” template. The discount provider can then select from among the recommended templates to initiate the offer. If the recommended offers do not appeal to the discount provider, the provider can manually select or specify another discount template.

The processes described herein for providing template-based discount valuation and ranking may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

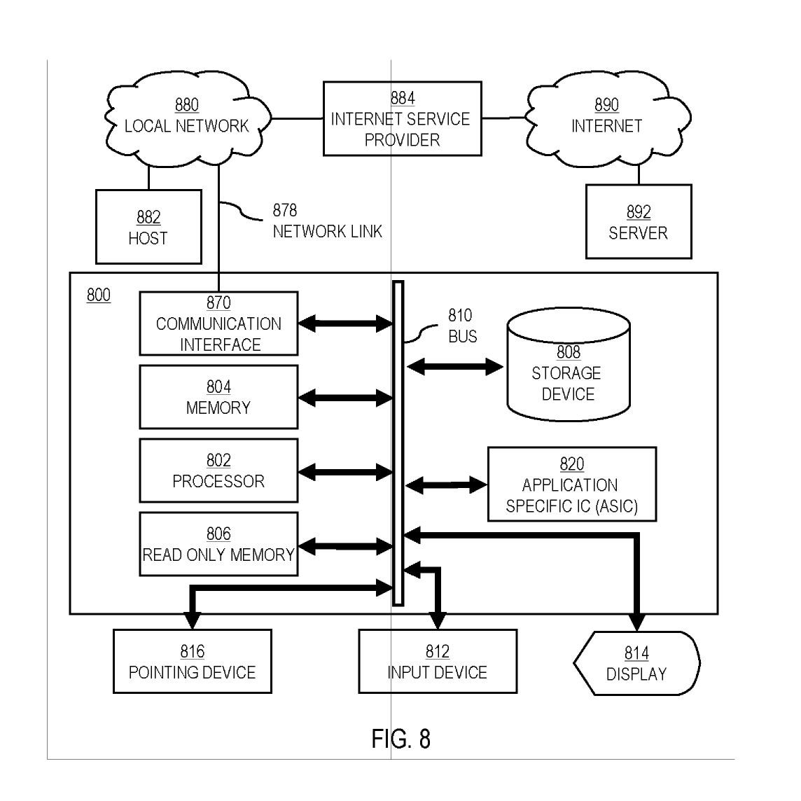

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide template-based discount valuation and ranking as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing template-based discount valuation and ranking.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing template-based discount valuation and ranking. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing template-based discount valuation and ranking. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing template-based discount valuation and ranking, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing template-based discount valuation and ranking to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide template-based discount valuation and ranking as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing template-based discount valuation and ranking.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide template-based discount valuation and ranking. The memory 905 also stores the data associated with or generated by the execution of the inventive steps.

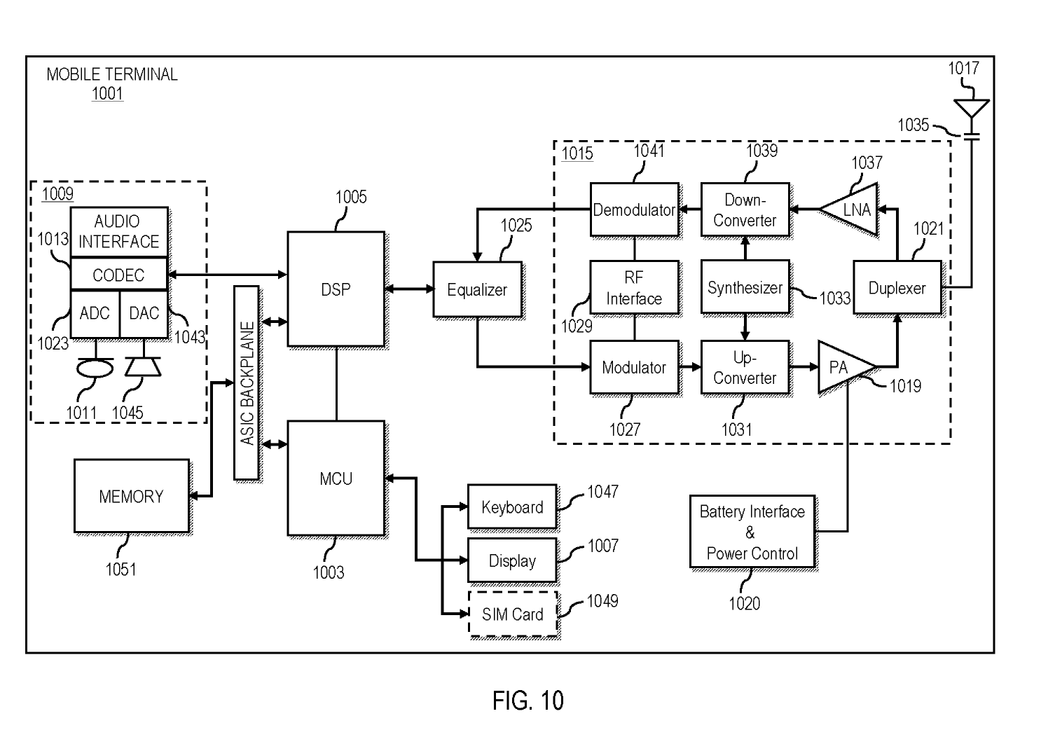

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing template-based discount valuation and ranking. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing template-based discount valuation and ranking. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide template-based discount valuation and ranking. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1.-43. (canceled)

44. A method comprising facilitating a processing of and/or processing (1) data and/or (2) information and/or (3) at least one signal, the (1) data and/or (2) information and/or (3) at least one signal based, at least in part, on the following:
a processing of a vocabulary for representing one or more discount parameters associated with one or more discount types; and
a processing of the one or more discount types to generate one or more templates based, at least in part, on the vocabulary,
wherein the one or more templates include, at least in part, one or more labels, one or more input fields, or a combination thereof for calculating and/or facilitating a calculation of one or more discount values associated with the discount information; and
wherein the one or more discount values include, at least in part, an economic value, a semantic value, or a combination thereof.

45. A method of claim 44, wherein the (1) data and/or (2) information and/or (3) at least one signal are further based, at least in part, on the following:
a first weight value of the economic value and a second weight value of the semantic value; and
a processing of the one or more discount values based, at least in part, on the first weight value, the second weight value, or a combination thereof.

46. A method of claim 44, wherein the (1) data and/or (2) information and/or (3) at least one signal are further based, at least in part, on the following:
at least one determination of at least one equation for calculating the one or more discount values based, at least in part, on data associated with the one or more input fields; and
an association of the at least one equation with the one or more templates;
wherein the at least one equation normalizes the one or more discount values across the one or more discount types.

47. A method of claim 44, wherein the (1) data and/or (2) information and/or (3) at least one signal are further based, at least in part, on the following:
a receipt of the discount information for one or more items;
a processing of the discount information to populate at least a portion of the one or more templates with at least one of the one or more discount parameters;
a processing of the discount information based, at least in part, on the one or more equations of the populated one or more templates to generate respective discount values for the one or more items; and
a processing of the respective discount values to generate a ranking the one or more of items based, at least in part, on the respective values of the one or more discounts.

48. A method of claim 47, wherein the (1) data and/or (2) information and/or (3) at least one signal are further based, at least in part, on the following:
a processing of profile information, context data, or a combination thereof associated with at least one user,
wherein the processing of the respective discount values to generate the ranking is further based, at least in part, on the profile information, the context data, or a combination thereof.

49. A method of claim 47, wherein the (1) data and/or (2) information and/or (3) at least one signal are further based, at least in part, on the following:
a processing of the respective discount values to generate a reminder notification regarding the one or more discounts.

50. A method of claim 47, wherein the receiving of the discount information for the one or more items includes, at least in part, causing at least in part capture of the discount information via sampling and recognition, reading of a bar code, reading of a near field communication tag, reading of a radio frequency identification tag, or a combination thereof.

51. A method of claim 47, wherein the (1) data and/or (2) information and/or (3) at least one signal are further based, at least in part, on the following:
at least one determination of a correlation between the one or more items and the one or more templates; and
a processing of at least the correlation to determine one or more recommended templates.

52. A method of claim 44, further comprising:
at least one determination of popularity information of the one or more templates with respect to one or more discount providers, one or more discount consumers, or a combination thereof; and
a processing of at least the popularity information to determine one or more recommended templates.

53. An apparatus comprising:
at least one processor; and
at least one memory including computer program code for one or more programs,
the at least one memory and the computer program code configured to, with the at least one processor, cause the apparatus to perform at least the following,
process and/or facilitate a processing of a vocabulary for representing one or more discount parameters associated with one or more discount types; and
cause, at least in part, processing of the one or more discount types to generate one or more templates based, at least in part, on the vocabulary,
wherein the one or more templates include, at least in part, one or more labels, one or more input fields, or a combination thereof for calculating and/or facilitating a calculation of one or more discount values associated with the discount information; and
wherein the one or more discount values include, at least in part, an economic value, a semantic value, or a combination thereof.

54. An apparatus of claim 53, wherein the apparatus is further caused to:
determine a first weight value of the economic value and a second weight value of the semantic value; and
process and/or facilitate a processing of the one or more discount values based, at least in part, on the first weight value, the second weight value, or a combination thereof.

55. An apparatus of claim 53, wherein the apparatus is further caused to:
determine at least one equation for calculating the one or more discount values based, at least in part, on data associated with the one or more input fields; and
cause, at least in part, an association of the at least one equation with the one or more templates;
wherein the at least one equation normalizes the one or more discount values across the one or more discount types.

56. An apparatus of claim 53, wherein the apparatus is further caused to:
receive the discount information for one or more items;
process and/or facilitate a processing of the discount information to populate at least a portion of the one or more templates with at least one of the one or more discount parameters;
process and/or facilitate a processing of the discount information based, at least in part, on the one or more equations of the populated one or more templates to generate respective discount values for the one or more items; and
process and/or facilitate a processing of the respective discount values to generate a ranking the one or more of items based, at least in part, on the respective values of the one or more discounts.

57. An apparatus of claim 56, wherein the apparatus is further caused to:
process and/or facilitate a processing of profile information, context data, or a combination thereof associated with at least one user,
wherein the processing of the respective discount values to generate the ranking is further based, at least in part, on the profile information, the context data, or a combination thereof.

58. An apparatus of claim 56, wherein the apparatus is further caused to:
process and/or facilitate a processing of the respective discount values to generate a reminder notification regarding the one or more discounts.

59. An apparatus of claim 56, wherein the receiving of the discount information for the one or more items includes, at least in part, causing at least in part capture of the discount information via sampling and recognition, reading of a bar code, reading of a near field communication tag, reading of a radio frequency identification tag, or a combination thereof.

60. An apparatus of claim 56, wherein the apparatus is further caused to:
determine a correlation between the one or more items and the one or more templates; and
process and/or facilitate a processing of at least the correlation to determine one or more recommended templates.

61. An apparatus of claim 53, wherein the apparatus is further caused to:
determine popularity information of the one or more templates with respect to one or more discount providers, one or more discount consumers, or a combination thereof; and
process and/or facilitate a processing of at least the popularity information to determine one or more recommended templates.

62. An apparatus of claim 53, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

63. A computer-readable storage medium carrying one or more sequences of one or more instructions which, when executed by one or more processors, cause an apparatus to perform at least the steps of:
processing and/or facilitating a processing of a vocabulary for representing one or more discount parameters associated with one or more discount types; and
processing and/or facilitating a processing of the one or more discount types to generate one or more templates based, at least in part, on the vocabulary,
wherein the one or more templates include, at least in part, one or more labels, one or more input fields, or a combination thereof for calculating and/or facilitating a calculation of one or more discount values associated with the discount information; and
wherein the one or more discount values include, at least in part, an economic value, a semantic value, or a combination thereof.
